(19) United States
(12) Patent Application Publication
(10) Pub. No.: US 2026/0031074 A1
(43) Pub. Date: Jan. 29, 2026

(54) System And Method for Generating Music-Driven Choreography Based on Music Feature Clusters and Dynamic

(71) Applicant: Centre for Intelligent Multidimensional Data Analysis Limited, Pak Shek Kok (HK)

(72) Inventors: Shuhong Lin, Pak Shek Kok (HK); Moshe Zukerman, Pak Shek Kok (HK); Hong Yan, Pak Shek Kok (HK)

(21) Appl. No.: 18/785,666

(22) Filed: Jul. 26, 2024

(51) Int. Cl. G10H 1/40; G09B 19/00

(52) U.S. Cl. CPC G10H 1/40; G09B 19/0015; G10H 2210/076; G10H 2210/375

(57) ABSTRACT

A method for generating a music-driven choreography based on the music feature clusters and dynamics, the method including the steps of: receiving a segment of input music; extracting a plurality of music features from the input music; generating a plurality of music segments based on musical beats; assigning music labels for each music segment; selecting a dance segment for each music segment by label similarity and an optimization process; and generating the music-driven choreography by combining the dance segments.

### TECHNICAL FIELD

This invention relates to a system and method for generating a music-driven choreography based on the music feature clusters and dynamic.

### BACKGROUND

For centuries dancing has played a significant role in human entertainment and culture as an artistic expression. Dancers on a stage may present a harmonious visual beauty by swaying their bodies according to the rhythm of the background music, so that participants, both dancers and spectators, enjoy the performance. Because of this feature, dancing is still popular even when people enter a virtual world. However, it is costly and challenging to create a virtual dance that looks natural based on a given piece of music.

Producers of virtual reality and game applications that involve virtual dancing often incur significant costs in employing professional choreographers and hiring motion-capture equipment. To achieve cost savings researchers have considered the development of computer-based choreography by using existing motion data as important. The main challenge arises from the relationship between music and human motion. There have been several approaches to address this.

Existing methods for choreography generation can be divided into two categories: (1) conventional methods based on feature similarity, and (2) methods based on neural networks.

US Patent U.S. Pat. No. 10,825,221 disclosed a neural network-based framework implemented by a two-stage sequence-to-sequence framework that generates human motion videos conditioned on input music. The prior art systems usually require a large amount of dance movement data. Public dance datasets obtained from professional dancers using motion capture equipment are highly accurate but rare because of the significant cost.

Further, most data sets are based on posture estimation of dance videos, giving dance movement data that are often noisy. Results obtained by estimating real 3D positions from the 2D positions in the video will inevitably contain larger errors than those obtained by motion capture equipment. These datasets often adopt different human skeletal models, so researchers can choose only one dataset as the training set of neural networks.

Unlike neural network-based approaches which suffer from freezing the action, approaches based on artificially designed features have better robustness. These approaches establish a relationship between dance movement and music segmentation. After building a music-motion database, a new dance can be produced according to the similarity of the features extracted from input music. Methods based on dynamic programming and motion graphs can be applied to organize candidate motions to avoid an exponential search space.

There is a need to provide a system and method for generating music-driven choreography based on music feature clusters and dynamic with little or no human intervention or for a continuous non-stop music session over a long period of time.

### SUMMARY OF THE INVENTION

Embodiments of the invention can provide a new dance generation method based on dynamic programming and the similarity of musical features.

In a preferred embodiment, the pre-processing phase comprises a dance's background music as the label of the dance movements to build a database of dance segments.

In a preferred embodiment, the generation phase comprises the same process as a pre-processing phase to generate labels for dance background music input by a user.

In a preferred embodiment, candidate dance segments are selected according to the similarity of labels of input dance and labels in the dance database.

In a preferred embodiment, candidate dance motions are organized by dynamic programming and generate transition motions between adjacent segments.

In a first aspect, there is provided a computer-implemented method for generating a music-driven choreography based on the music feature clusters and dynamics.

The computer-implemented method comprises a computer-implemented method for generating a music-driven choreography, comprising the steps of: receiving a segment of input music; extracting a plurality of music features from the input music; generating a plurality of music segments based on musical beats; assigning music labels for each music segment; selecting a dance segment for each music segment by label similarity; and generating the music-driven choreography by combining the dance segments.

In one example, the input music is divided into a plurality of music features wherein one or more of the music features correspond to musical beats.

Optionally, the step of generating a plurality of music segments comprises the step of dividing the input music into music segments using music beats as boundaries.

In one example, the music features are classified as from one or more raw music features comprising any one of 20-dimensional Mel-frequency cepstral coefficients (MFCC), 12-dimensional chroma, a 1-dimensional envelope, and a 1-dimensional one-hot peak.

Optionally, the music features are classified based on an ability to capture different aspects of music comprising spectral content, pitch information, dynamics, and specific frequency components.

In one example, the music features are classified by combining the one or more raw music features that representation of each audio signal of the music feature.

Optionally, the music labels are assigned by clustering music features to measure similarity between music segments.

In one example, the music labels are assigned based on a step of musical beats and the music feature clustering.

Optionally, the step of musical beats and the music feature clustering comprising the steps of extracted from the audio signal of the raw music features; reducing dimensionality of the raw music features with principal component analysis (PCA); clustering music feature vectors with K-means clustering algorithm; and assigning a unique music label to represent the different clusters.

In one example, the step of assigning music labels comprises a step of comparing a probability distribution function of the input music with that of music data in a training dataset and choosing a predetermined n-closest music data.

Optionally, dance segments from the predetermined n-closest music data are selected.

In one example, a dynamic programming process is applied to select dance segments by minimizing a cost function that contains two terms: a music distance and a pose distance.

Optionally, the PDFs on a time interval from a first beat to a ith beat are used to determine an ith dance segment.

In one example, the dynamic programming process is adapted to focus on matching the music features of a current segment selection.

Optionally, each dance segment contains a first pose and a final pose.

In one example, a pose equation is applied to obtain a difference, Dₚₒₛₑ, between the final pose of a last segment and the first pose of a next segment.

Optionally, the pose equation is Dₚₒₛₑ (pₐ, p_{b})=∥pₐ−T_{θ,xo,zopPb}∥ wherein adjacent motion segments to obtain the total 3D-position distance, denoted Dₚₒₛₑ, between two human poses, pₐ and p_{b}, linear transformation T_{θxo,zo} rotates a human pose p_{b} about the vertical axis by θ and translates by (xₒ, 0, zo).

In one example, the pose is defined as an SMPL skeleton containing a root node, 23 joint nodes, and a plurality of bones, wherein each joint represents a key point of a human body, and each bone represents a link between two different joints.

Optionally, after two adjacent dance segments are determined, last five frames from a last segment and first five frames from a next segment are used to generate a three-frame transition motion between the two segments.

In one example, the computer-implemented method further comprises a step of assigning a dance segment to a plurality of music segments with different rhythms by transferring discrete pose sequences to a continuous motion curve and modifying a length of motion segments and a movement speed by resampling.

Optionally, the dance dataset comprises sequences of 3D human dance motions paired with corresponding music data.

In one example, each frame of the sequence is represented by a human skeleton model which is a representation of the human pose.

Optionally, the human skeleton model comprises bones and joints, each joint represents a key point of the human body, and each bone represents a link between two different joints.

In one example, each sequence of 3D human dance motions comprises a time series of human poses which describes an SMPL skeleton containing a root node and 23 joint nodes.

Optionally, the dance dataset comprises data from AIST++ database.

In one example, a dance segment comprises kinematic beats that is synchronized with musical beats within that dance segment

Optionally, dance segments obtained after segmentation comprise different lengths in accordance with different rhythms of the background music in the dance dataset

In one example, music labels are assigned to label dance segments, wherein music-feature-labels are adapted to measure similarity between music segments of varying lengths

Optionally, the musical similarity is determined by discrete probability distribution of each segment and average Kullback-Leibler (KL) divergence of the music-features of the dance segments.
comprising a step of generating motion features containing a pose with local rotations of 24 joints and the corresponding global position.
wherein the pose is generated by segment connection and transition motion generation using 3-dimensional position of the SMPL skeleton model
wherein 3D positions of all joints can be derived by forward kinematics
wherein the pose of the human body is determined by the global position of the root joint and the orientation of all joints, wherein the length of the bones that connect adjacent joints is assigned as a constant value
the constant value is determined by averaging lengths of bones from different dancers in the dataset
adapted to utilize a 3-dimensional position for segment connection and transition motion generation

In a second aspect, there is provided a system comprising a processor and memory storing a computer program configured to be executed by the processor. The computer program comprises

In a third aspect, there is provided a carrier medium carrying computer-readable instructions arranged to cause a computer to perform or facilitate performing of the computer-implemented method of the first aspect. In one example, the carrier medium comprises a computer-readable medium. In one example, the computer-readable medium is a non-transitory computer-readable storage medium, which stores a computer program configured to be executed by a computer. The computer program comprises instructions for performing or facilitating performing of the computer-implemented method of the first aspect.

In a fourth aspect, there is provided a computer program comprising instructions which, when the program is executed by a computer, cause the computer to carry out the computer-implemented method of the first aspect.

Other features and aspects will become apparent by consideration of the following detailed description and the accompanying drawings. Any feature(s) described herein in relation to one aspect or embodiment may be combined with any other feature(s) described herein in relation to any other aspect or embodiment, as appropriate and applicable.

As used herein, unless otherwise specified, terms of degree such that “generally”, “about”, “substantially”, or the like, are intended to account for manufacture tolerance, degradation, trend, tendency, imperfect practical condition(s), etc. Also, unless otherwise specified, the terms “connected”, “coupled”, “mounted” or the like used herein are intended to encompass both direct and indirect connection, coupling, mounting, etc.

### BRIEF DESCRIPTION OF THE DRAWINGS

Some embodiments of the invention will now be described, with reference to the accompanying drawings, in which:

FIG. 1 is a schematic diagram of a computer server which is arranged to be implemented as a system for synthesizing MRI-MIP from MRI data in accordance with an embodiment of the present invention;

FIG. 2 is a process flow diagram of a method for generating music-driven choreography based on music feature clusters and dynamic in accordance with an embodiment of the present invention;

FIG. 3 is a schematic diagram of the structure of the SMPL skeleton and the correspondence between SMPL joint names and indices in accordance with an embodiment of the present invention;

FIG. 4 is a schematic diagram illustrating the feature vectors are extracted from audio signals and synchronized with the dance motion. The red blocks indicate the beats in accordance with an embodiment of the present invention;

FIG. 5 is a schematic diagram illustrating music labels of dance segments based on musical beats and the music feature clustering in accordance with an embodiment of the present invention;

FIG. 6 is a schematic diagram illustrating a self-distance matrix corresponding to background music called “mWA4” in the AIST++ in accordance with an embodiment of the present invention;

FIG. 7 is a schematic diagram illustrating derivation of the probability distribution functions in accordance with an embodiment of the present invention;

FIG. 8 is a schematic diagram illustrating examples of dance motions generated by our method. Each row represents a different dance motion in accordance with an embodiment of the present invention;

FIG. 9 is a schematic diagram illustrating examples of dance motions generated by our method and other state-of-the-art methods in accordance with an embodiment of the present invention.

### DETAILED DESCRIPTION OF THE PREFERRED EMBODIMENTS

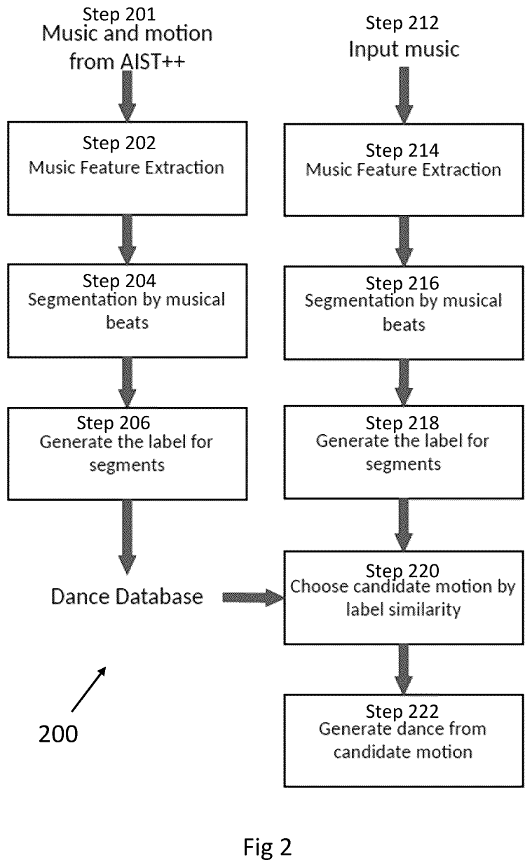

Reference is now made to FIG. 2 which illustrates a method 200 for generating a music-driven choreography based on the music feature clusters and dynamic in one embodiment of the invention. The method 200 is a computer-implemented method. In this embodiment, the method 200 is adapted to generate a music-driven choreography. The method 200 comprises the steps of: receiving a segment of input music in Step 212; extracting a plurality of music features from the input music in Step 214; generating a plurality of music segments based on musical beats in Step 216; assigning music labels for each music segment in Step 218; selecting a dance segment for each music segment by label similarity in Step 220; and generating the music-driven choreography by combining the dance segments in Step 222.

In one embodiment, the method 200 comprises a process of assigning labels to a dance dataset in a database. The process of assigning labels to a dance dataset in a database comprising the steps of: retrieving music and motions from a dance dataset in Step 201, extracting a plurality of music features from the music and motions in Step 202, generating a plurality of dance segments based on musical beats in Step 204; assigning music labels for each dance segment in Step 206. Each dance segment contains a first pose and a final pose.

In one embodiment, the input music is divided into a plurality of music features wherein one or more of the music features correspond to musical beats. The step of generating a plurality of music segments comprises the step of dividing the input music into music segments using music beats as boundaries. The music features are classified as from one or more raw music features comprising any one of 20-dimensional Mel-frequency cepstral coefficients (MFCC), 12-dimensional chroma, a 1-dimensional envelope, and a 1-dimensional one-hot peak.

The music features are classified based on an ability to capture different aspects of music comprising spectral content, pitch information, dynamics, and specific frequency components. The music features are classified by combining the one or more raw music features that representation of each audio signal of the music feature.

In one embodiment, the music labels are assigned by clustering music features to measure similarity between music segments. The music labels are assigned based on a step of musical beats and the music feature clustering. The step of musical beats and the music feature clustering comprising the steps of: extracted from the audio signal of the raw music features; reducing dimensionality of the raw music features with principal component analysis (PCA); clustering music feature vectors with K-means clustering algorithm; and assigning a unique music label to represent the different clusters.

The step of assigning music labels comprises a step of comparing a probability distribution function of the input music with that of music data in a training dataset and choosing a predetermined n-closest music data. The dance segments from the predetermined n-closest music data are selected. A dynamic programming process is applied to select dance segments by minimizing a cost function that contains two terms: a music distance and a pose distance.

The PDFs on a time interval from a first beat to a ith beat are used to determine an ith dance segment. The dynamic programming process is adapted to focus on matching the music features of a current segment selection.

A pose equation is applied to obtain a difference, Dₚₒₛₑ, between the final pose of a last segment and the first pose of a next segment. The pose equation is Dₚₒₛₑ (pₐ, p_{b})=∥pₐ−T_{θ,xo,zopb}∥ wherein adjacent motion segments to obtain the total 3D-position distance, denoted Dₚₒₛₑ, between two human poses, pₐ and pp, linear transformation T_{θ,xo,zo} rotates a human pose p_{b} about the vertical axis by θ and translates by (xₒ, 0, zₒ).

The pose is defined as an SMPL skeleton containing a root node, 23 joint nodes, and a plurality of bones, wherein each joint represents a key point of a human body, and each bone represents a link between two different joints.

After two adjacent dance segments are determined, last five frames from a last segment and first five frames from a next segment are used to generate a three-frame transition motion between the two segments.

In one embodiment, a dance segment is adapted to be assigned to a plurality of music segments with different rhythms by transferring discrete pose sequences to a continuous motion curve and modifying a length of motion segments and a movement speed by resampling.

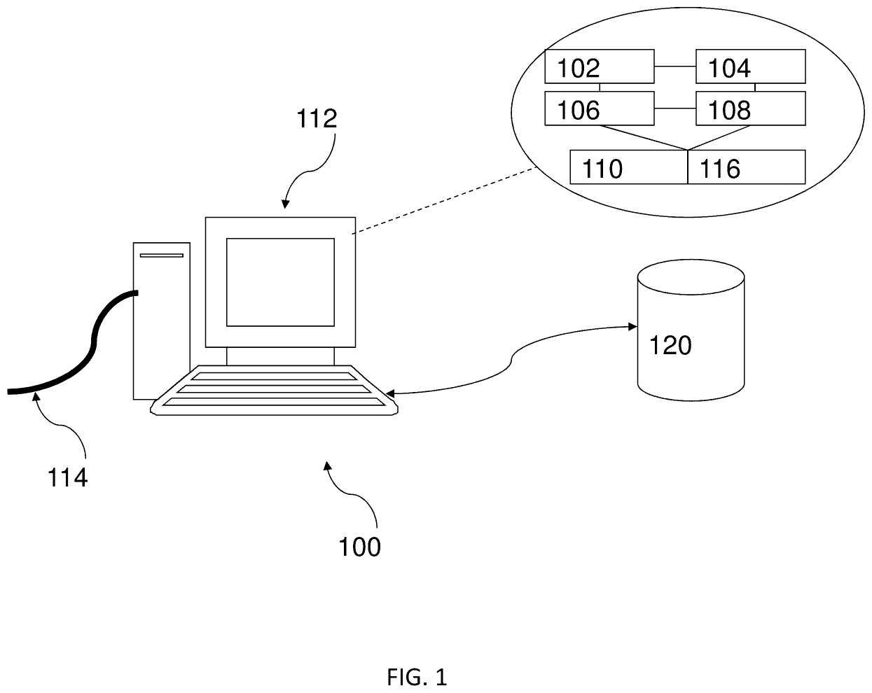

As shown in FIG. 1, there is a shown a schematic diagram of a computer system or computer server 100 which is arranged to be implemented as an example embodiment of a system for generating a music-driven choreography based on the music feature clusters and dynamic in one embodiment of the invention as shown in FIG. 2.

In one embodiment of the present invention, the system comprises a server 100 which includes suitable components necessary to receive, store, and execute appropriate computer instructions. The components may include a processing unit 102, including one or more Central Processors, Graphic Processing Units (GPUs) or Tensor Processing Units (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display, or any other suitable display and communications links 114. The system 100 may include instructions that may be included in ROM 104, RAM 106, or disk drives 108 and may be executed by the processing unit 102.

There may be provided a plurality of communication links 114 which may variously connect to one or more computing devices such as a server, personal computers, terminals, wireless or handheld computing devices, and edge computing devices. At least one of a plurality of communications links may be connected to an external computing network through a telephone line or other type of communications link.

The server 100 may include storage devices such as a disk drive 108 which may encompass solid state drives, hard disk drives, optical drives, magnetic tape drives, or remote or cloud-based storage devices. The server 100 may use a single disk drive or multiple disk drives, or a remote storage service 120. The server 100 may also have a suitable operating system 116 which resides on the disk drive or in the ROM of the server 100.

One embodiment of the present invention is adapted to generate a new music label based on the probability distribution function using music features. This label can be applied to music segments of different lengths, and by using the Kullback-Leibler divergence (KL divergence). The embodiment of the present invention can determine the similarity of music segments based on this label. The music similarity measurement of the embodiment of the present invention can be applied to dance segments of varying lengths. This distinguishes the present invention from existing methods for dance generation, as the present invention is not constrained by the duration of the music segments. Consequently, it significantly broadens the range of dance segments that can be selected, offering more possibilities to create new dances.

To make the motion sequences adaptable to different music rhythms, the embodiments of the present invention employ cubic splines to represent dance movements. This allows the embodiment of the present invention to control the speed of a dance sequence by resampling it, thereby adapting to different rhythms based on the tempo of newly input music.

Details method of the dance synthesis in an embodiment of the present invention is described. The method of the dance synthesis consists of two main stages. The first stage is to establish a dance motion database consisting of a sufficiently large number of dance segments with their corresponding musical labels, and the second stage is to synthesize a new dance according to the particular audio signal input digital data provided by the user.

### A. Dance Motion Database

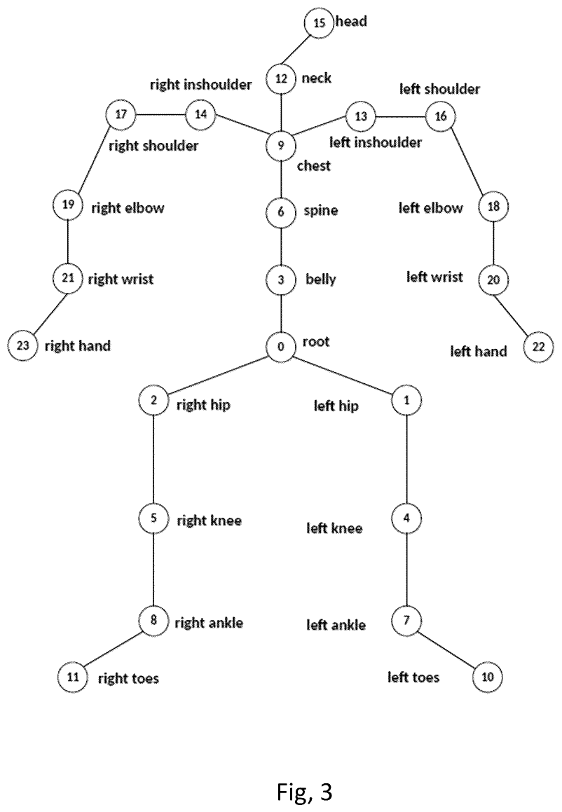

On embodiment of the present invention used a dance dataset called AIST++. Other embodiments may use a proprietary dance dataset built using 3D motion-capturing devices or using an AI engine to convert 2D media data into a dance dataset. AIST++ is a large human dance motion dataset. It contains 1,408 sequences of 3D human dance motions paired with corresponding music data. Each frame of the sequence is represented by a human skeleton which is a popular representation of the human pose. It consists of bones and joints. Each joint represents a key point of the human body, and each bone represents a link between two different joints as shown in FIG. 3. There are two kinds of human skeletons in AIST++: (1) Common Objects In Context (COCO) format with 17 joints, and (2) Skinned Multi-Person Linear Model (SMPL) format with 24 joints.

In another embodiment, the dance dataset may comprise motion datasets of robotic devices, such as robot arms, robot legs, or robot dogs. The dataset may contain sequences of 3D robotic device motions paired with corresponding music data. Each frame of the sequence is represented by a robotic device skeleton which is a representation of the robotic device pose. Each pose may consist of bones and joints. Each joint represents a key point of the robotic device body, and each bone represents a link between two different joints. The robotic device skeletons in the datasets may be stored in a Skinned Multi-Person Linear Model (SMPL) format with a predefined number of joints for each robotic device.

In one implementation of the present invention, AIST++ can be divided into several non-overlapping parts for cross-modal analysis between human motion and music data. Around two-thirds of sequences are randomly selected from the dataset and divided into a training and a testing dataset. In one implementation of the present invention, the entire AIST++ dataset can be used as a training dataset to establish the dance motion database.

In one implementation of the present invention, a dance motion sequence in AIST++ can be used as a time series of human poses and denoted as X={x₁, x₂, . . . , x_{T}}. Each human pose is represented by a vector xₜ=(p_{t,0}, q_{t,0}, q_{t,1}, . . . , q_{t,23}) which describes a Skinned Multi-Person Linear (SMPL) skeleton containing a root node and 23 joint nodes as shown in FIG. 3. The root node of the SMPL skeleton is represented by a 3-dimensional coordinate p_{t,0} ∈ [symbol] ₃ and a unit quaternion q_{t,0} ∈ [symbol] ₄. The 3-dimensional coordinate and the unit quaternion represent the position of the skeleton and the global rotation of the skeleton, respectively. The structure of the SMPL skeleton and the correspondence between SMPL joint names and indices are shown in FIG. 3. For each joint node, a unit quaternion q_{t,j} ∈ [symbol] ₄ is adapted to indicate its relative rotation with respect to its parent joint. To represent each human pose in the motion sequences of the embodiment of the present invention, a vector is created by concatenating a 3-dimensional position vector and 24 4-dimensional quaternions. This results in a vector with a total dimensionality of 3+24×4=99 for each human pose.

A method of division of the entire dance sequence into segments in accordance with an embodiment of the present invention is described below.

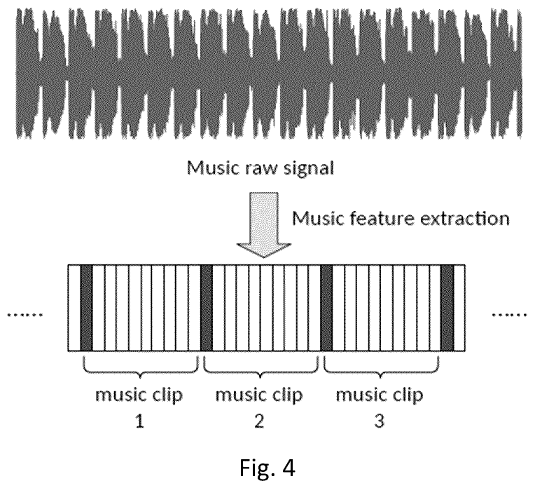

According to an embodiment of the present invention, it is assumed that there is a strong correlation between musical and kinematic beats along the time axis and the original dance in the database is well synchronized with the corresponding music, and dancers will start or terminate actions at the time of musical beats. In another embodiment of the present invention, a database containing dance moves that are well-synchronized music having a strong correlation between musical and kinematic beats along the time axis is created. Thus, musical beats are clues to detect the boundaries of a dance segment. As shown in FIG. 4, the raw musical features are extracted from the raw music signal and generated with the same number of music feature vectors as the number of poses. In FIG. 4, each rectangle represents a music feature vector and the red blocks represent music feature vectors corresponding to the musical beats. These musical beats are used as boundaries to divide the entire dance into several short segments. These dance segments have an advantage over poses as units for choreography because the kinematic beats can always synchronize with the musical beats within the same dance segment.

One embodiment of the present invention uses musical features to analyze musical structure, music generation, and choreography generation. In one implementation of an embodiment of the present invention, 20-dimensional Mel-frequency cepstral coefficients (MFCC), 12-dimensional chroma, a 1-dimensional envelope, and a 1-dimensional one-hot peak are selected as the raw music features. The details are shown in Table 1.

TABLE I
The music features we used.

| Music feature | Dimension | Feature function |
|---|---|---|
| Onset Strength | 1 | The amplitude variations over time |
| Envelope | | in an audio signal. |
| Mel-Frequency Cepstral | 20 | Simulate the auditory |
| Coefficients | | characteristics of the human ear. |
| Chroma Energy | 12 | Quantify the distribution of |
| Normalized | | musical pitch classes. |
| Peak of Onset Strength | 1 | The presence of peaks or |
| Envelope | | prominent local maxima in a given |
| | | spectrogram. |

The selection of these features is based on the ability to capture different aspects of music, including spectral content, pitch information, dynamics, and specific frequency components. By combining these features, a comprehensive representation of each audio signal can be obtained. In one embodiment, an audio and music signal analysis API library, such as Librosa in Python is used for tracking beats in audio signals.

Musical and kinematic features together are adopted in an embodiment of the present invention as the label of the dance segments. In an embodiment of the present invention, there are provided two representations for pose similarity measures: the positions and rotations of joints. The problem with the position of joints is how to keep spatial invariance when Euclidean distance is used to measure the similarity of postures. For example, the Euclidean distance between two similar poses facing different directions may be significant. The local rotation of joints is a better presentation than the 3D position to keep the spatial invariance because similar poses always have similar local rotations of joints, even if the joints face different directions. One embodiment of the present invention is adapted to consider prediction errors (caused by differences between the ground-truth poses and the predicted poses) in different joints which make it difficult to determine the weight of each joint in the similarity measure. For example, the same rotational difference has a more significant effect in spinal joints than in limb joints. To address this issue, an embodiment of the present invention is adapted to only use music features to measure the similarity between segments because the audio signal has less noise and is more robust. In one embodiment, the AIST++ dataset is configured so that each dance genre has several background music tracks and there exists a one-to-many relationship between background music and dance motion. Thus, the music features are enough for the dance genre and motion selections.

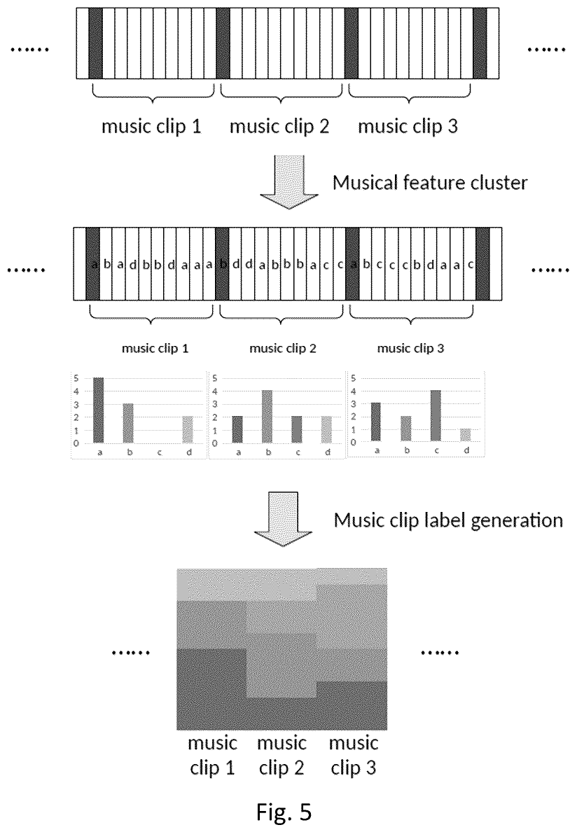

Dance segments obtained after segmentation have different lengths because the rhythms of the background music in the dance dataset used are different. One embodiment of the present invention uses music-feature-based labels that are adapted to measure the similarity between music segments of varying lengths. As shown in FIG. 5, the raw music features are extracted from the audio signal, and then principal component analysis (PCA) is applied for dimensionality reduction. Next, the embodiment of the present invention is adapted to use the K-means clustering algorithm to divide the music feature vectors into clusters. As shown in FIG. 5, different letters are adopted as labels to represent the different clusters. To measure the musical similarity of dance segments, the embodiment of the present invention calculates the discrete probability distribution of each segment and uses the average Kullback-Leibler (KL) divergence to measure the similarity of the two music pieces. For two discrete probability distributions Q and P, the distance between them is obtained by:

$$Dis ( P , Q ) = \frac{1}{2} ( DKL ( P ‖ Q ) + DKL ( Q ‖ P ) ) \qquad ( 1 )$$

where D_{KL}(P∥Q) is the KL divergence from Q to P:

$$DKL ( P ‖ Q ) = {\sum }_{x = 1}^{K} P ( x ) log ( \frac{P ( x )}{Q ( x )} ) \qquad ( 2 )$$

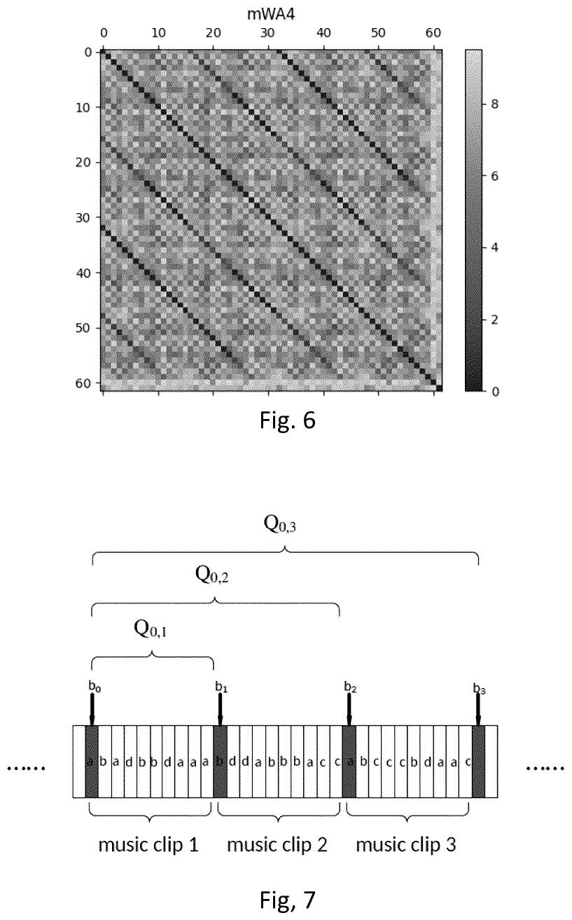

and P (x) and Q(x) are the discrete probability distribution functions (PDFs) of the labels of the input music and the music from the database (ground truth), respectively. K is the number of clusters and is set by the user. This music-feature-based label was used to analyze the structure of music. As shown in FIG. 6, the embodiment of the present invention uses a piece of music in the dance dataset to generate the self-distance matrix. Both vertical and horizontal axes are time indexes. Dark colors represent high similarity and light colors represent low similarity. The pattern of diagonal lines in the self-distance matrix represents repetitive parts of the music data.

As shown in FIG. 6, the self-distance matrix of the sample music can describe its structure.

One embodiment of the present invention is adapted to utilize a 3-dimensional position for segment connection and transition motion generation.

In one embodiment of the present invention, the SMPL skeleton with 24 joints is chosen as the human skeleton, and the SMPL skeleton is described by joint rotation, the 3D positions of all joints can be derived by forward kinematics. Because the length of the bones that connect adjacent joints is assumed to be constant, the pose of the human body is determined by the global position of the root joint and the orientation of all joints.

The motion capture data in the dance dataset used in an embodiment of the present invention comes from different dancers with different body shapes. To facilitate the motion analysis, the lengths of the skeletons for different dancers need to be adjusted so that the same bones on different dancers have the same length, the average lengths of the bones from different dancers are calculated and then adjusted the bone lengths to their average lengths. After the information on the lengths of all of the bones, the position of the root joint, and the global position of the skeleton is obtained, the positions of the remaining 23 joints can be calculated using forward kinematics by employing the rotational data of the joints relative to each other to determine their respective positions.

Because a person may have similar poses in different directions, the joints' relative position is used concerning the root joint and applied motion editing algorithm to connect the adjacent motion segments to obtain the total 3D-position distance, denoted Dₚₒₛₑ, between two human poses, pₐ and p_{b}, as:

$${D}_{pose} ( {p}_{a} , {p}_{b} ) = ‖ {p}_{a} - {T}_{θ , xo , zo} {p}_{b} ‖ \qquad ( 3 )$$

$$θ = arctan ( \frac{{\sum }_{j} {ω}_{j} ( {x}_{a , j} {z}_{b , j} - {x}_{b , j} {z}_{a , j} ) - ( {\overline{x}}_{a} {\overline{z}}_{b} - {\overline{x}}_{b} {\overline{z}}_{a} )}{{\sum }_{j} {ω}_{j} ( {x}_{a , j} {z}_{b , j} + {x}_{b , j} {z}_{a , j} ) - ( {\overline{x}}_{a} {\overline{x}}_{b} + {\overline{z}}_{a} {\overline{z}}_{b} )} ) \qquad ( 4 )$$

$${x}_{o} = {\overline{x}}_{a} - {\overline{x}}_{b} cos θ - {\overline{z}}_{b} sin θ \qquad ( 5 )$$

$${z}_{o} = {\overline{z}}_{a} + {\overline{x}}_{b} sin θ - {\overline{z}}_{b} cos θ \qquad ( 6 )$$

where x̅ₐ=Σⱼ ωⱼx_{a,j} and Σⱼ ωⱼ=1. The linear transformation T_{θ,xo,zo} rotates a human pose pp about the vertical axis by θ and translates it by (xₒ, θ, zₒ) so that the initial pose of the next motion segment can be adjusted to a position and orientation as similar as possible to the current pose.

The 3D positions of all joints are not enough for character animation generation. For instance, the 3D position alone cannot fully capture the twisting motion of a bone. Thus, the final result of the generated dance by our method is described by the global position of the root joint and the orientation of all joints.

To make the same dance segment fit music with different rhythms, an embodiment of the present invention is adapted to transfer the discrete pose sequence to a continuous motion curve. Then the length of the motion segments and the movement speed can be modified by resampling to address the insufficiency of the limited data. The motion features contain the local rotation of 24 joints and their global position. Accordingly, 25 cubic splines can be derived by the embodiment of the present invention as motion curves for each segment. For the trajectory of the root joint, one embodiment of the present invention adopted a cubic Hermite spline. On a given time interval, the position of the root joint p (t) can be expressed by a polynomial, as follows.

$$p ( t ) = {h}_{00} ( t ) {p}_{0} + {h}_{01} ( t ) ( {x}_{1} - {x}_{0} ) {m}_{0} + {h}_{10} ( t ) {p}_{1} + {h}_{11} ( t ) ( {x}_{1} - {x}_{0} ) {m}_{1} \qquad ( 6 )$$

where

$$t = \frac{x - {x}_{0}}{{x}_{1} - {x}_{0}} .$$

The m₀ and m₁ are the tangents of p(t) at its endpoints p(x₀) and p (x₁), respectively.

$${h}_{00} ( t ) = 2 {t}^{2} - 3 {t}^{3} + 1 \qquad ( 6 )$$

$${h}_{01} ( t ) = {t}^{3} - 2 {t}^{2} + t \qquad ( 6 )$$

$${h}_{10} ( t ) = - 2 {t}^{2} + 3 {t}^{3} \qquad ( 6 )$$

$${h}_{11} ( t ) = {t}^{3} - {t}^{2} \qquad ( 6 )$$

One advantage of the cubic Hermite spline is that it can keep the velocity and the position in the keyframes and produce smooth curves. For the rotation, we used the quaternion cubic spline which can produce a smooth curve between two poses and keep the angular velocity of the endpoints. The main idea of the quaternion Cubic Spline is based on the Cubic Spline, and both are used in animation.

The cubic spline was also applied in motion transition. After two adjacent dance segments are determined, the last five frames from the last segment and the first five frames from the next segment are used to generate a three-frame transition motion between the two segments.

When the user inputs new music data into the system as shown in FIG. 1, the system implements an embodiment of the present invention to execute the steps to divide the new music data into segments and use the same parameters for the PCA and K-means clustering to generate labels for these segments, as shown in FIG. 5. To speed up the generation, an embodiment of the present invention compared the probability distribution function of the complete input music data with that of the music data (ground truth) in the training dataset and chose the n-closest music data, where n is set by the user. One embodiment of the present invention only selects the segments from these music data as the candidate segments so that there is no need to search for candidate segments among the entire training dataset.

Having selected the n-closest music data, the embodiment applies dynamic programming to select candidate dance segments by minimizing a cost function that contains two terms: the music distance and the pose distance. The optimization problem is formulated as follows.

$$min ( {\sum }_{i = 2}^{N} [ {D}_{pose} ( {p}_{i - 1}^{end} - {p}_{i}^{start} ) + λ {D}_{is} ( {P}_{0 , i} - {Q}_{0 , i} ) ] + {D}_{pose} ( {p}^{initial} - {p}_{1}^{start} ) ) \qquad ( 12 )$$

where p^{initial} is the initial pose, and

$${p}_{i}^{start} and {p}_{i}^{end}$$

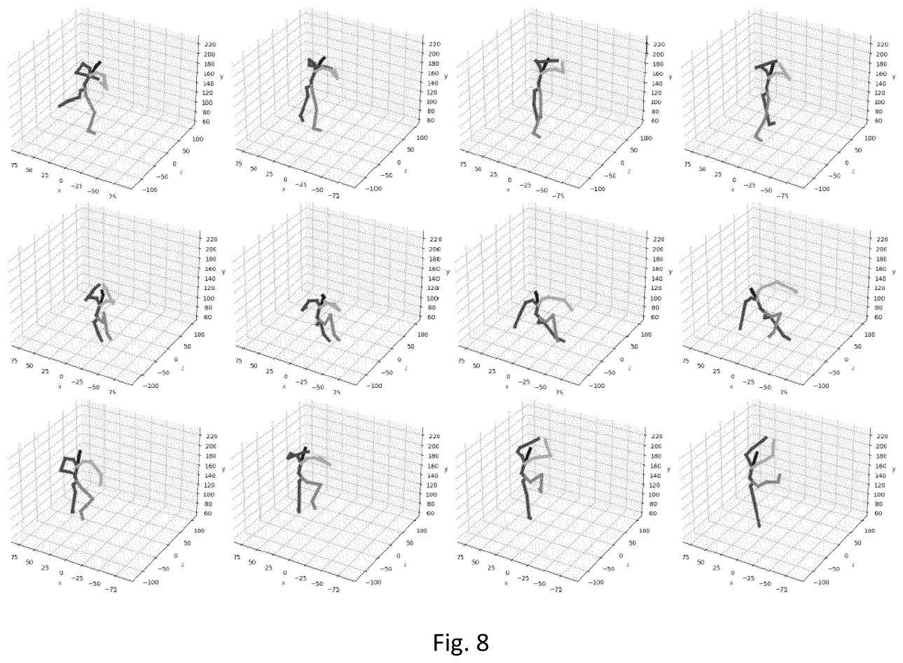

are the first and last poses of ith segment, respectively. The variable p_{0,i} is the music label's PDF of the first i selected segments, and Q_{0,i} is the PDF of the first i music segments of the input music. When the embodiment of the present invention determines the ith candidate segment, there is no need to use the pairwise KL divergence between the PDFs of the ith input music clips and the ith candidate segment from the database. Instead, the embodiment of the present invention is adapted to use the PDFs on the time interval from the first beat to the ith beat as shown in FIG. 7. The latter approach is adopted in an embodiment of the present invention because the former approach will make the dynamic programming process focus on matching the music features of the current segment selection, while the latter considers matching the music features of the entire dance sequence. In another embodiment, the former approach may be used as an alternative.

In FIG. 7, it is illustrated how to derive the PDFs for the Dynamic Programming procedures. The symbol Q_{0,i} is the PDF of the first i music segments of the input music. The symbols b₀, b₁, etc. represent the locations of the music beats. The clusters corresponding to the music features of each frame are represented by different lowercase letters. Because one implement of the present invention is adapted to use the music beats as the boundaries of the segment, the locations of these beats are important to calculate the PDF as it is based on the music features from the start of the dance up to the current beats, rather than just the music features between the current and previous beats.

In one embodiment Equation (3) is applied to obtain the difference, Dₚₒₛₑ, between the final pose of the last segment and the first pose of the next segment, instead of the Euclidean distance of the coordinates of the corresponding joints, because the Euclidean distance may include a difference in a position that is not related to the change of pose. For example, if there is no change in the pose, i.e., Dₚₒₛₑ=0, there can be a change in position, so the Euclidean distance will not be zero.

The method of embodiment of the present invention is compared to three neural network-based methods: DanceRevolution, FACT, and Bailando. The other neural network-based methods were retrained with the dance dataset that was used in an embodiment of the same invention to achieve a fair comparison with the method of the present invention.

The dance dataset used in the experiment was AIST++ which provided 992 pieces of dance paired with music. There were 952 pieces of dance motion for training, 20 pieces for testing, and 20 pieces for evaluation. Including the data in the test group, some of the experiments used randomly paired music and motion seeds. Because users may use randomly paired music and dance motions as input in practice, the test dataset we used also contains the randomly paired music and dance motions. The same dance movements and music combinations were used in some of the experiments. The FACT experiments used a 10-second motion seed from the ground-truth dance motion to generate different dances based on the same music and different motion seeds. Similarly, the first frame from the ground-truth was used dance motion as the initial pose of the method of the present invention. Some experimental systems were designed to assist with mutual choreography. Two methods different in some of the experiments for mutual choreography were employed: random generation or improvised (selecting dance movements recommended according to music features by their algorithm) and manual choreography based on the algorithm's recommendations. In one implementation of the method of the experiments, the first method based on random selection was employed, but for some implementations, a manual selection of dance movements selection was employed.

DanceRevolution uses a skeleton with 25 joints, and the human poses are represented by the position of the joints. For a fair comparison, we adjusted the number of output action parameters and retrained the model using the AIST++ training dataset rather than using the pre-trained model provided by the authors. The dances in AIST++ have varying lengths, while all the dance clips in the DanceRevolution dataset are one minute long. Thus, 10-second overlapping clips every two seconds were taken to make all the training dance clips have equal lengths to facilitate network training. DanceRevolution always begins each dance with the same initial pose, regardless of the specific dance performed. Another difference between our method and DanceRevolution is that the music from the DanceRevolution dataset contains lyrics while some embodiments of the present invention do not. The hyperparameters used in the neural network training of some embodiments of the present invention were the same as those in other compared experimental systems.

The performance of the methods in the experiment was measured from three perspectives by five metrics.

1) Motion quality: The Fréchet Inception Distances (FID) have been popular for measuring the similarity between ground-truth and synthetic images using generative models (e.g., a GAN). FID was used to assess the similarity between features of the generated dance and all ground-truth dances in AIST++. The lower the FID, the more similar the synthetic dance is to the ground-truth dance.

The details of the FID calculation are provided to measure the distance between two features extracted from two datasets. The FID was introduced as an evaluation metric for synthetic data, and it is included here for completeness.

$$FID ( {s}_{gt} , {s}_{gen} ) = {‖ {u}_{gt} - {u}_{gen} ‖}_{2}^{2} + tr ( {\sum }_{gt} - {\sum }_{gen} + 2 {( {\sum }_{gt} {\sum }_{gen} )}^{\frac{1}{2}} ) \qquad ( 13 )$$

where s_{gi}, s_{gen} are the sets of features extracted from the ground-truth and generated datasets and have mean vectors u_{gt}, u_{gen} and covariance matrices Σ_{gt}, Σ_{gen}, respectively. The trace of a square matrix is denoted by tr(·). The first term of Equation (13) is the squared Euclidean distance between the two mean vectors, u_{gt}, u_{gen}, and the second term is the trace of the following square matrix.

$$⌊ {\sum }_{gt} - {\sum }_{gen} + 2 {( {\sum }_{gt} {\sum }_{gen} )}^{\frac{1}{2}} ⌋$$

Accordingly, the FID will be different depending on the features used. Two kinds of FID were calculated, denoted FIDₖ and FID_{g}, that were obtained based on the distributions of the kinetic and geometric features, respectively. The kinetic features represent the velocity of the motion, and the geometric features represent the geometric relative position between different joints. Both FIDs, FIDₖ and FID_{g}, are used in human motion generation.

2) Motion diversity: To measure the diversity of the generated motion, the average Euclidean distances for kinetic and geometric features were calculated as Distₖ and Dist_{g}, respectively. For each feature type, kinetic and geometric, we calculated the Euclidean distances between any two features for the generated dance motions and then averaged them to obtain the evaluation of motion diversity.

3) Music-dance alignment: As in previous studies, the average temporal distance between each music beat and its closest kinematic beat was calculated as follows.

$$\frac{1}{\vert {B}_{m} \vert} {\sum }_{{t}_{rn} ∈ {B}_{rn}} exp ( - \frac{{min}_{{t}^{d}} ∈ {B}^{d} {‖ {t}^{d} - {t}^{m} ‖}^{2}}{2 {σ}^{2}} ) \qquad ( 14 )$$

where Bₘ and B^{d} are the sets of the times of music and kinematic beats, respectively. The parameter σ was set to be 3.

The quantitative results of the AIST++ test set are shown in Table II. The method of an embodiment of the present invention (denoted as “Ours”) was compared with other methods: Lee et al., DanceRevolution, FACT, and Bailando.

According to the comparison, the method of an embodiment of the present invention consistently outperformed all other existing approaches in the vast majority of evaluations.

The method of an embodiment of the present invention performs significantly better than the prior methods in terms of the similarity of kinetic and geometric features between the ground-truth and generated dances. The random selection shows a weak ability in dance generation because these methods simply replicated the dance clips from the dance dataset. The human manual selection significantly improves the scores in all evaluation metrics, but other existing methods still suffer the same problems as manual selection. The lower score in music-dance alignment indicates the segmentation algorithm of the embodiment of the present invention performs better than segmentation based on the novelty function used by the prior methods. Specifically, the method of the present invention improves by 20.33 (58.93%) over the best-compared baseline model, FACT, on FIDₖ that evaluates the similarity of the kinetic features between a ground-truth and generated dance by using kinetic features related to the velocity of all joints to calculate the similarity. Directly using the dance movements from the dataset does not yield a lower FIDₖ score. The method proposed by one prior system also used dance clips from the dataset to organize a new dance. Through experiments, it was found a high FIDₖ score when manually selecting appropriate dance segments. Hence, replicating dance segments from the dataset alone did not yield satisfactory results. Experiments showed a significant relationship between musical rhythm and joint velocity in dance. In one approach of the present invention, cubic splines were utilized to regulate the speed of joint movements based on the background music's rhythm rather than just a replication from the dataset. For FID_{g}, a 1.09 (9.71%) improvement was achieved over Bailando which achieved the best performance among the three baseline methods. Lower FIDₖ and FID_{g} means the difference in the statistics of the kinetic and geometric features between the generated motion and the ground-truth motion is smaller. Thus, the generated motion sequences of the method of the present invention have a more similar distribution to the ground-truth motion sequences in AIST++.

In terms of motion diversity, the method of the present invention obtained a better result for Distₖ (9.86 versus 9.50), while Bailando and FACT have better performance than the method of the present invention in Dist_{g} (5.64 versus 6.52). However, Bailando has a relatively high value for FIDₖ and shows a lower score for music-dance alignment. The diversity of motion generated by the method of the present invention is better than the baseline in the kinetic feature space. In the geometric feature space, the neural network-based approaches show better performance. The beat-alignment score in Table II shows better performance by the method of the present invention than the baseline methods in synchronization between musical and kinematic beats. The third row is a kick action from the dance.

TABLE II
Quantitative results on the AIST++ test set with random pairs of
music and initial pose; ↑ means the larger score is better while ↓
means the lower score is better; bold values represent the best results for each column.

| | FIDₖ ↓ | FID_{g} ↓ | Distₖ ↑ | Dist_{g} ↑ | BeatAlign ↑ |
|---|---|---|---|---|---|
| AIST++ (Ground Truth) | | | 10.0212 | 7.3223 | 0.283 |
| Lee et al. (random) [2] | 497.3034 | 32.2086 | 22.8797 | 3.6424 | 0.202 |
| Lee et al. (manual) [2] | 68.1100 | 22.7618 | 11.9332 | 5.1348 | 0.215 |
| DanceRevolution [10] | 85.1973 | 44.9465 | 1.7390 | 4.2113 | 0.203 |
| FACT [9] | 34.4971 | 16.4088 | 7.9224 | 6.1689 | 0.217 |
| Bailando [15] | 62.3286 | 11.2768 | 9.5037 | 6.5164 | 0.194 |
| Ours | 14.1669 | 10.1839 3 | 9.8634 5. | 6391 | 0.26 |

As shown in FIG. 8, there is presented twelve frames to demonstrate dance motion generated by an embodiment of the present invention. Each row of four frames represents motion from a generated dance. The animation comprises 60 frames per second and the presented frames were extracted every 10 frames and are separated by 1 6-second time-periods.

Different bones are distinguished by different colors. The first and second rows show two dance motions in a standing and a sitting state, respectively, while the motion in the third row is a kick, demonstrating our method can generate complex dance motions.

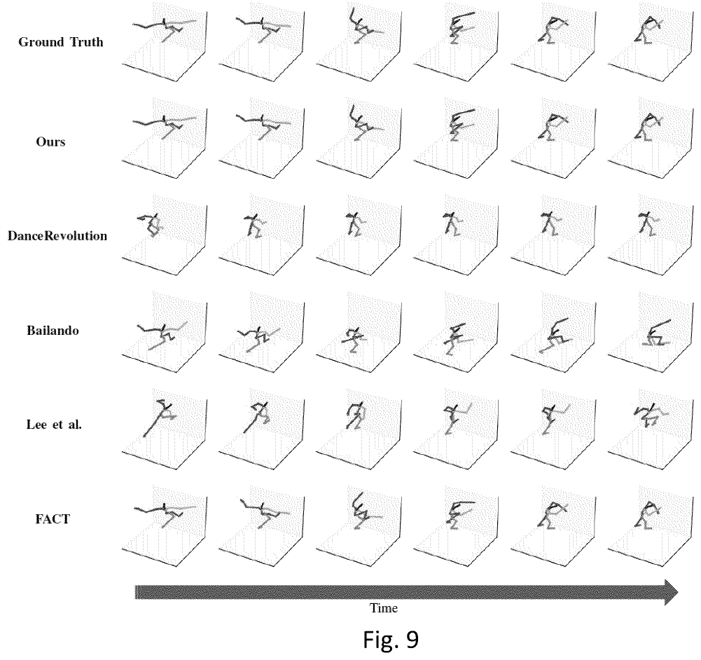

As shown in FIG. 9, a dance achieved by the method of the present invention (denoted as “Ours”) was compared against dances generated by the other methods: the method of Lee et al., DanceRevolution, FACT, and Bailando. The first row displays the ground truth dance movement from the test dataset. Then, each row displays a short sequence of dance generated by a specific method, with each column aligned in time. The time interval between adjacent frames remains constant. Based on FIG. 9, it was observed that the method of the present invention achieved a significantly better performance relative to the conventional method proposed by Lee et al. and that FACT has achieved the best performance among the three neural network-based methods. The method of the present invention performed better than FACT in some of the metrics. For instance, in the third column, the generated pose of the left forearm using the method of the present invention exhibited a closer resemblance to the real data than the pose generated by FACT.

To further compare to Bailando, the results of two other experiments are presented. The first experiment was to generate a 20-second output, while the other one aimed to generate an entire dance. The results of the generated dance based on the first 20-second output are shown in Table III, and those on the entire dance are shown in Table IV. In Tables III and IV, it is observed that the method of the present invention performed significantly better than Bailando when the test dataset contains random pairs of music and initial poses. When the test dataset does not contain the random pairs of background music and initial poses, Bailando has a slightly better performance in about half of the metrics such as FID_{g}. The clear advantage of the method of the present invention is in the case where the test dataset contains random pairs of music and initial poses. This demonstrates that the method of the present invention is more robust, which is especially important because users may use their background music and initial poses as input, and the pair of background music and initial poses used might not be the same as the data in the training dataset.

TABLE III
Comparison based on the first 20 seconds of generated dance.

| | FIDₖ ↓ | FID_{g} ↓ | Distₖ ↑ | Dist_{g} ↑ |
|---|---|---|---|---|
| Bailando* | 28.1616 | 9.6258 | 7.8373 | 6.3446 |
| Ours* | 12.1742 | 11.0592 | 8.7406 | 5.8964 |
| Bailando | 27.7354 | 9.5659 | 7.5485 | 6.1969 |
| Ours | 11.7145 | 8.3338 | 8.3129 | 5.8381 |

The symbol * indicates that the test dataset does not contain random pairs of music and initial poses, and ↑ indicates that larger is better while ↓ indicates that lower is better.

There is a one-to-many relationship between background music and dance movement in AIST++. Bailando may not have considered the impact of this relationship, which may be the reason for their lower score observed in Tables Ill and IV for the test dataset with random pairs of music and initial pose.

TABLE IV
Comparison based on the complete generated dance.

| | FIDₖ ↓ | FID_{g} ↓ | Distₖ ↑ | Dist_{g} ↑ |
|---|---|---|---|---|
| Bailando* | 64.8358 | 11.2058 | 9.8364 | 6.6346 |
| Ours* | 18.5848 | 12.6156 | 9.7680 | 5.4900 |
| Bailando | 62.3286 | 11.2768 | 9.5037 | 6.5164 |
| Ours | 14.1669 | 10.1839 3 | 9.8634. | 5.6391 |

The symbols *, ↑ and ↓ have the same meaning as in Table III.

The value of FIDₖ becomes relatively high in long-term dance generation as shown in Table IV, suggesting difficulty in capturing the rhythm of a longer dance. Bailando has achieved a better result for the short-term dance generation than the long-term dance generation. Our method can perform better when the user inputs a random pair of music and initial pose because our method considers the one-to-many relationship between background music and dance movement in AIST++.

An ablation study was conducted to explore the influence of musical feature selection. In addition to using the musical features given in Table I, a combination without chroma, and a combination without MFCCs were tested as shown in Table V. The performance is best if both MFCCs and chroma are used as input musical features. All four evaluation metrics indicate a significant performance decline without either MFCCs or chroma. The MFCCs have a greater impact on FIDₖ, Disₖ, and Dis_{g}, while chroma has a greater impact on FID_{g}.

In conclusion, the present invention provides a new dance generation method based on dynamic programming and the similarity of music features. The new method of the present invention is adapted to generate labels of corresponding dance segments according to the clustering of music features. To compare the similarity between dance segments with varying time lengths, KL divergence is used between the discrete probability distribution functions of music features that can indicate the structure of the background music.

The method in accordance with the present invention also adapted to use a cubic spline to adjust the length of the dance segments to accommodate different musical rhythms so that the same clip of background music can be matched with more dance moves. Because there is a one-to-many relationship between background music and dance movements, one embodiment of the present invention is adapted to use the background music and initial pose of the dance as the input, allowing the method of the present invention to generate different dance motions based on the same background music.

The dances generated by the method in accordance with an embodiment of the present invention have been compared with those of neural network-based methods, and the quantitative evaluation shows superior performance by our method for long-term dance generation.

The present invention provides a new method for comparison with some existing methods.

### A. Conventional Methods Based on Feature Similarity

These follow a decomposition-combination process: (1) decompose the complete dance in the dance database into small segments, each of which consists of several frames; (2) extract musical and motion features from each segment; (3) select candidate segments or dance segments and combine them according to the similarity of their features. The key difference between the conventional methods based on feature similarity is that the method of the present invention can generate vibrant dances automatically without any human intervention, while their method requires human selection to organize dance segments, as an aid for manual choreography. Specific methodological differences between this prior art approach are that the prior art used an average of music feature vectors within corresponding time intervals to generate motion data labels while the method of an embodiment of the present invention provides the incorporation of the distribution function of music feature vectors within the corresponding time intervals. This allows the method of the present invention to consider finer details of dance features during the dance generation process.

The method of the present invention first performs clustering on all frames of the music in the database. Then, the distribution function of the clusters in each segment is used as the label for that segment. Based on the method of the present invention, the data labels obtained can preserve more temporal information.

Conventional methods based on feature similarity decompose the entire dance into several segments and then reorganize these segments to generate a new dance according to the input music. Because dance movements directly come from ground truth data, the generated dance movements are realistic.

However, the entire dance is divided into segments according to the rhythm which decides the length of the segment, and these methods cannot adjust the length of segments. As a result, specific motion segments can only be synchronized with music that has specific rhythms. This may adversely affect efficiency when using the already limited dance motion data.

A Recurrent Neural Network (RNN) predicts the next frame according to its last output and its current hidden states, which makes it popular for motion generation.

In the conventional RNN training phase, the RNN is recursively given a sequence of ground truth motion data rather than its own training output. Such a prior art method increases the speed of training but leads to error accumulation in the test phase because the RNN is unaware of the ground-truth data in this phase.

The disclosed transformer training models usually generate the dance motion frame by frame. The dance is regarded as a sequence of poses so that the neural networks are trained to learn the relationships between poses. However, a short dance combines hundreds of poses. So this strategy makes it easier for errors to accumulate and makes the training process of neural networks more time-consuming.

While some of the embodiments described above relate to dance choreography for animation or computer graphics, some embodiments may further convert dance choreography to robotic device instructions for controlling the movement of the robotic devices. One implementation for robotic devices comprises the steps of generating a set of robotic device instructions corresponding a pose within a sequences in the dance segment such that the robot device may change the pose in accordance with the selected dance segments in the generated choreography.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive.

1. A computer-implemented method for generating a music-driven choreography, comprising the steps of:
receiving a segment of input music;
extracting a plurality of music features from the input music;
generating a plurality of music segments based on musical beats;
assigning music labels for each music segment;
selecting a dance segment for each music segment by label similarity; and
generating the music-driven choreography by combining the dance segments.

2. A computer-implemented method according to claim 1, wherein the input music is divided into a plurality of music features wherein one or more of the music features correspond to musical beats.

3. A computer-implemented method according to claim 2, wherein the step of generating a plurality of music segments comprises the step of dividing the input music into music segments using music beats as boundaries.

4. A computer-implemented method according to claim 3, wherein the music features are classified as from one or more raw music features comprising any one of 20-dimensional Mel-frequency cepstral coefficients (MFCC), 12-dimensional chroma, a 1-dimensional envelope, and a 1-dimensional one-hot peak.

5. A computer-implemented method according to claim 4, wherein the music features are classified based on an ability to capture different aspects of music comprising spectral content, pitch information, dynamics, and specific frequency components.

6. A computer-implemented method according to claim 5, wherein the music features are classified by combining the one or more raw music features that representation of each audio signal of the music feature.

7. A computer-implemented method according to claim 6, wherein the music labels are assigned by clustering music features to measure similarity between music segments.

8. A computer-implemented method according to claim 7, wherein the music labels are assigned based on a step of musical beats and the music feature clustering.

9. A computer-implemented method according to claim 8, wherein the step of musical beats and the music feature clustering comprising the steps of extracted from the audio signal of the raw music features;
reducing dimensionality of the raw music features with principal component analysis (PCA);
clustering music feature vectors with K-means clustering algorithm; and
assigning a unique music label to represent the different clusters.

10. A computer-implemented method according to claim 9, wherein the step of assigning music labels comprises a step of comparing a probability distribution function of the input music with that of music data in a training dataset and choosing a predetermined n-closest music data.

11. A computer-implemented method according to claim 10, wherein dance segments from the predetermined n-closest music data are selected.

12. A computer-implemented method according to claim 11, wherein a dynamic programming process is applied to select dance segments by minimizing a cost function that contains two terms: a music distance and a pose distance.

13. A computer-implemented method according to claim 12, wherein the PDFs on a time interval from a first beat to a ith beat are used to determine an ith dance segment.

14. A computer-implemented method according to claim 13, wherein the dynamic programming process is adapted to focus on matching the music features of a current segment selection.

15. A computer-implemented method according to claim 14, wherein each dance segment contains a first pose and a final pose.

16. A computer-implemented method according to claim 15, wherein a pose equation is applied to obtain a difference, Dₚₒₛₑ, between the final pose of a last segment and the first pose of a next segment.

17. A computer-implemented method according to claim 16, wherein the pose equation is
$${D}_{pose} ( {p}_{a} , {p}_{b} ) = ‖ {p}_{a} - {T}_{θ , x o , z o} {p}_{b} ‖$$
wherein adjacent motion segments to obtain the total 3D-position distance, denoted Dₚₒₛₑ, between two human poses, pₐ and p_{b}, linear transformation T_{θ,xo,zo} rotates a human pose p_{b} about the vertical axis by θ and translates by (xₒ, 0, zₒ).

18. A computer-implemented method according to claim 17, wherein the pose is defined as an SMPL skeleton containing a root node, 23 joint nodes, and a plurality of bones, wherein each joint represents a key point of a human body, and each bone represents a link between two different joints.

19. A computer-implemented method according to claim 18, wherein after two adjacent dance segments are determined, last five frames from a last segment and first five frames from a next segment are used to generate a three-frame transition motion between the two segments.

20. A computer-implemented method according to claim 19, further comprising a step of assigning a dance segment to a plurality of music segments with different rhythms by transferring discrete pose sequence to a continuous motion curve and modifying a length of motion segments and a movement speed by resampling.
